(19) United States
(12) Patent Application Publication
(10) Pub. No.: US 2004/0020589 A1
(43) Pub. Date: Feb. 5, 2004

(54) Hot melt adhesive

(76) Inventors: David J. Good, Somerville, NJ (US); William L. Wallace, Memphis, TN (US); Dale L. Haner, Ringwood, NJ (US); Charles W. Paul, Madison, NJ (US); Brian D. Morrison, Lebanon, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/209,977

(22) Filed: Aug. 1, 2002

(51) Int. Cl. B01D 29/07; B32B 3/28; B32B 7/14; C08J 3/02; C09J 9/00

(52) U.S. Cl. 156/227; 156/291; 156/327; 516/98; 210/493.1; 428/181

(57) ABSTRACT

A hot melt adhesive that exhibits distinct gellation properties at application temperatures at some time following application to a substrate. Adhesive having gellation properties are particularly useful in the manufacture of pleating articles, such as pleated filters.

### FIELD OF THE INVENTION

The invention relates to hot melt adhesives that exhibit gelatin structure and gelatin properties. The adhesives find use in a number of areas and are particularly well-suited for filter pleating applications.

### BACKGROUND OF THE INVENTION

Typical thermoplastic hot melt adhesives are comprised of a thermoplastic polymer, tackifier, wax or plasticizing oil, and possibly other conventional additives. In the past a great deal of attention has been given to the properties of these formulated materials in the adhesive melt (liquid) and bonded (solid) form. Since hot melts are applied in their molten liquid state, then bonded and cooled to its solid state, the liquid and solid state performance of the hot melt naturally determine its aptitude for machining and bonding in a desired application. As such, attention has been focused toward the solid and liquid properties.

Consideration of the liquid solid transition has predominantly been addressed only in tailoring the timing of its occurrence. A molten liquid adhesive must remain molten through the bonding process and begin to solidify when the adhesive wets the two substrates. Hardening or “setting” of the adhesive prior to wetting of the substrates inhibits bond formation.

Crystallization is a relatively quick transition from a liquid to solid and is characteristic of waxes and to some degree semi-crystalline polymers. Peak and onset crystallization temperatures of hot melts are often modified to target a certain post application time period for the crystallization to occur. Ideally hot melt adhesive crystallization and transition to a solid would occur rapidly just after the substrates where compressed with adhesive. This rapid solidification would set the bond quickly at its permanent strength. In actuality the adhesive begins the solidification process the moment it leaves the application nozzle and cooling occurs before the substrates are compressed with the adhesive. This amount of cooling prior to bond formation is also accounted for when developing the appropriate phase transition timing.

In contrast to what is known of the properties of adhesives in the liquid and solid state, considerably less is known about adhesive properties during transition between the liquid and solid form. Manipulation of this transition state may be used to modify the properties and uses of adhesives. A need thus exist in the art for hot melt adhesive formulations specifically tailored to create a state intermediate to the liquid and solid states that lead to modified adhesive performance. The current invention addresses this need.

### SUMMARY OF THE INVENTION

The invention is directed to a hot melt adhesive having an altered liquid solid phase transition. The adhesives of the invention are formulated to go through a gelatin state that is intermediate to the liquid and solid form. The properties of this gelatin state are unique from that of liquids or solids and can be formulated to have desired performance advantages and process requirements. The invention provides a hot melt adhesive exhibiting gelatin structure and gelatin properties during application or any time thereafter.

The hot melt adhesive formulations of the invention go through a distinct gel state wherein a liquid phase is trapped within an interlocking three dimensional network, also referred to herein as the solid phase. The solid phase comprises a gelling agent. The liquid phase comprises a thermoplastic polymer, a tackifier and optionally a wax. The gelling agent is advantageously a polyethylene (PE) homopolymer or copolymer wax, most preferably a branched PE wax. In a preferred embodiment, the liquid phase comprises an ethylene vinyl acetate copolymer and a hydrocarbon tackifying resin, and the solid phase comprises a branched PE wax. The branched PE wax precipitates to form a physical cross-linked network in an otherwise molten formulation of ethylene vinyl acetate copolymer, synthetic wax, and hydrocarbon tackifying resin. In one embodiment, the adhesive displays gelation properties over at least a 25° F. temperature range at or below the application temperature.

Another aspect of the invention is directed to an article of manufacture comprising a hot melt adhesive that exhibits gelatin properties. The article is preferably made of paper, paperboard or the like. Encompassed by the invention are containers, e.g., cartons, cases, boxes, bags, trays and the like. Particularly useful articles of manufacture comprise pleated article such as pleated filters and the like formed using the adhesive of the invention.

Still another aspect of the invention is directed to a process for bonding a substrate to a similar or dissimilar substrate comprising applying to at least a first substrate a molten hot melt adhesive composition, bringing a second substrate in contact with the composition applied to the first substrate, whereby the first and second substrates are bonded together, wherein said hot melt adhesive exhibits gelatin properties. In one embodiment the adhesive applied to one substrate is contacted to the adhesive applied to a second substrate to bond the first substrate to the second substrate.

Yet another aspect of the invention is directed to a method of making a pleated article. A pleated article may be formed by applying at least one line of the adhesive to a substrate to be pleated. The substrate is folded, e.g., with a conventional pleating machine, to form pleats, which pleats are substantially perpendicular to the direction of the line of adhesive. When pleated, adhesive present on one surface of a pleat contacts adhesive present on a surface of an adjacent pleat forming a bond and holding the article in pleated form. Preferable at least two lines of adhesive are applied to the substrate, said lines of adhesive running parallel to and at a predetermined distance from one another.

### BRIEF DESCRIPTION OF THE DRAWING FIGURES

FIGS. 1-3 are micrographs that illustrate the precipitated PE network of an adhesive in a gelatin state.

FIG. 1 is a micrograph of an adhesive in a gelatin state with ten percent gellant additive at 120.5° C.

FIG. 2 is a micrograph of an adhesive in a gelatin state with ten percent gellant additive at 149.9° C.

FIG. 3 is a micrograph of an adhesive in a gelatin state with twenty percent gellant additive.

FIGS. 4A and 4B are micrographs of an adhesive lacking a gellant.

FIG. 5 is a graph comparing bond forces versus bond time for two gelatin (♦ and ▪) and one control standard (Δ) hot melt adhesive. The standard hot melt has substantially lower bond forces in the one to three second range indicating a lower green strength.

FIG. 6 is a rheology trace comparing the storage modulus of two gelatin (-♦-♦- and -Δ-Δ-) and one control standard (-▪-▪-) hot melt adhesive. The standard hot melt has substantially lower storage modulus around the application indicating a lower green strength.

### DETAILED DESCRIPTION OF THE INVENTION

All documents cited herein are incorporated in their entireties by reference.

It has now been discovered that properties present during transition of an adhesive from a liquid to a solid state may be manipulated to alter the properties of the adhesive and expand the end uses thereof. In particular, it has been discovered that addition of a gellant to a hot melt adhesive formulation may be used to modify, as desired, the transition that occurs between the liquid and solid phase. In particular, the semisolid gelatin properties of the adhesive can be adjusted by changing the loading level of the gellant, particulate size or molecular size of the gellant, adhesive temperature, and solvent/molten system.

The type of adhesive that can be used in the practice of the invention is not particularly limiting or critical to the practice of the invention. Typically, adhesive formulations to which the gellant additive of the invention may be added comprise a thermoplastic polymer, a tackifier and preferably also a non-gel forming wax or diluent, and/or other conventional additives such as antioxidants and stabilizers in varying amounts as are known to those skilled in the art and as required for particular formulations.

Hot melt adhesives of the invention may be prepared using techniques known in the art. Typically, the adhesive compositions are prepared by blending the components in the melt at a temperature of about 1000 to 200° C. until a homogeneous blend is obtained, usually about two hours. Various methods of blending are known and any method that produces a homogeneous blend is satisfactory.

Hot melt compositions of the invention will typically comprise a gellation agent, an adhesive (base) polymer, a tackifier and, preferably, also a wax. In a preferred embodiment, the adhesive copolymer comprises at least one ethylene copolymer and the gellation agent is a polyethylene wax.

The gellant, also referred to herein as a gelling agent, may be added, with stirring, any time during the preparation of the adhesive. The amount added will depend on the type of gellant, the particulate size or molecular size of the gellant, the desired application temperature, the size and the dissolution or dispersion properties. The gellant is added in an amount effective to form a structural gel during the transition from a liquid (molten) state to the solid form of the adhesive. Typically, the gellant will be present in an amount of about 0.5 to about 40 percent by weight of the adhesive composition.

Any combination of ingredients may be used to prepare the adhesive as long as distinct gelatin properties are achieved at application temperatures or at a desired temperature following application to the substrate. Specifically, ingredients are used in amounts sufficient to form a three-dimensional lattice network comprised of precipitated gellant. The existence of this network in conjunction with a liquid phase comprised of the polymer and/or tackifier components creates gelatin properties by restricting the flow of the liquid phase.

The structural definition of a gel as used herein is a semisolid system in which a liquid phase is trapped within an interlocking three-dimensional network. The three-dimensional network of interest to this invention is comprised of a wax or polymer (gellant) with strong chemical interactions, physical cross-linking, or chemical cross-linking. The interactions between gellant molecules are such to secure the individual strands and produce a stable yet compliant network structure. The liquid phase is comprised of tackifier, wax or plasticizing oil, base polymer, and other optional ingredients in their molten state. Gelatin properties that coincide with the gel structure include increased elongation, resistance to liquid like deformation or flow, and shear thinning or thixotropic behavior.

Any base polymer suitable for use in formulating hot melt adhesives, as are well known to those skilled in the art may be used in the practice of the invention. Such polymers include amorphous polyolefins, ethylene-containing polymers and rubbery block copolymers, as well as blends thereof. In a preferred embodiment, the adhesive comprises at least one ethylene copolymer, and may comprise a blend of two or more polymers. The term ethylene copolymer, as used herein, refers to homopolymers, copolymers and terpolymers of ethylene. The polymer component will usually be present in an amount of from about 10% to about 60%, more preferably from about 20% to about 45%, more preferably from about 25% to about 35%. Examples of ethylene copolymers include copolymers with one or more polar monomers which can copolymerize with ethylene, such as vinyl acetate or other vinyl esters of monocarboxylic acids, or acrylic or methacrylic acid or their esters with methanol, ethanol or other alcohols. Included are ethylene vinyl acetate, ethylene methyl acrylate, ethylene n-butyl acrylate, ethylene acrylic acid, ethylene methacrylate and mixtures and blends thereof. Other examples include but are not limited to recycled polyethylene terphthalate and polyethylene, ethylene/a-olefin interpolymers, poly-(butene-1-co-ethylene), atactic polypropylene, low density polyethylene, 2-ethyl hexyl acrylate copolymers with ethylene and or vinyl acetate, homogenous linear ethylene/a-olefin copolymers, lower melt index n-butyl acrylate copolymers, ethylene vinyl ester copolymers). Random and block copolymers, as well as blends thereof may be used in the practice of the invention.

The desired polar monomer content in the ethylene copolymer is generally from about 1 to about 60 wt %, preferably 15 to 45 wt %, more preferably over 25 wt %. The ethylene copolymer preferably has a melt index of from about 10 to about 5000 grams/10 minutes.

Particularly preferred adhesives will comprise ethylene vinyl acetate. Preferably, the ethylene vinyl acetate component comprises less than about 40% vinyl acetate. Ethylene vinyl acetate copolymers are commercially available from DuPont Chemical Co., Wilmington, Del. under the tradename Elvax® (e.g., Elvax® 210 which has a melt index of 400 grams/10 minutes and a vinyl acetate content of 28% by weight in the copolymer, Elvax® 205W which has a melt index of 800 and a vinyl acetate content of about 28% by weight in the copolymer and Elvax® 410 which has a melt index of 500 and a vinyl acetate content of about 18% by weight). Other ethylene vinyl acetate copolymers are available from Exxon Chemical Co. under the tradename Escorene® (e.g., UL 8705) and also from Millennium Petrochemicals, Rolling Meadows, Ill., under the tradename Ultrathene® (e.g., UE 64904) and AT® copolymers available from AT Polymers & Film Co., Charlotte, NC (e.g., AT® 1850M).

Preferred gellants for use in the practice of the invention are low molecular weight polyethylene (PE) homopolymer or copolymer waxes and blends thereof. Included are oxidized homopolymers, oxidized high-density polyethylene, ethylene vinyl acetate, ethylene acrylic acid, and maleic anhydride copolymers. Gellants such as A-C® polyethylene gels available from Allied Signal and EPOLENE® available from Eastman Chemical Company may advantageously be used in the practice of the invention. The gellant will typically be used in amounts of from about 0.5 to about 40 percent by weight.

The adhesive compositions of this invention are preferably tackified. The tackifying component will typically be used in amounts of from about 10 to about 60 weight percent, more typically from about 25 to about 45 weight percent, by weight of the adhesive composition.

Preferred tackifiers are synthetic hydrocarbon resins derived from petroleum. Non-limiting examples of include aliphatic olefin derived resins such as those available from Goodyear under the Wingtack® tradename and the Escorez® 1300 series from Exxon. A common C₅ tackifying resin in this class is a diene-olefin copolymer of piperylene and 2-methyl-2-butene having a softening point of about 95° C. This resin is available commercially under the tradename Wingtack 95. The resins normally have ring and ball softening points as determined by ASTM method E28 between about 20° C. and 150° C. Also useful are C₉ aromatic/aliphatic olefin-derived resins available from Exxon in the Escorez 2000 series. Hydrogenated hydrocarbon resins are especially useful when the long term resistance to oxidation and ultraviolet light exposure is required. These hydrogenated resins include such resins as the Escorez 5000 series of hydrogenated cycloaliphatic resins from Exxon, hydrogenated C₉ and/or C₅ resins such as Arkon® P series of resins by Arakawa Chemical, hydrogenated aromatic hydrocarbon resins such as Regalrez® 1018, 1085 and the Regalite® R series of resins from Hercules Specialty Chemicals. Additional aromatic modified hydrocarbon resins include the Zonatac® series from Arizona Chemical Company. Other useful resins include hydrogenated polyterpenes such as Clearon® P-105, P-115 and P-125 from the Yasuhara Yushi Kogyo Company of Japan.

Waxes suitable for use in the present invention include paraffin waxes, microcrystalline waxes, high density low molecular weight polyethylene waxes, by-product polyethylene waxes, Fischer-Tropsch waxes, oxidized Fischer-Tropsch waxes and functionalized waxes such as hydroxy stearamide waxes and fafty amide waxes. It is common in the art to use the terminology synthetic high melting point waxes to include high density low molecular weight polyethylene waxes, by-product polyethylene waxes and Fischer-Tropsch waxes. Modified waxes, such as vinyl acetate modified and maleic anhydride modified waxes may also be used. The wax component is utilized at levels of greater than about 10 weight percent, typically about 20 to 40 weight percent, by weight of the adhesive.

The paraffin waxes useful herein are those having a ring and ball softening point of about 55° C. to about 85° C. Preferred paraffin waxes are Okerin® 236 TP available from Astor Wax Corporation, Doraville, Ga.; Penreco® 4913 available from Pennzoil Products Co., Houston, Tex.; R-7152 Paraffin Wax available from Moore & Munger, Shelton, Conn.; and Paraffin Wax 1297 available from International Waxes, Ltd. in Ontario, Canada. Particularly preferred are paraffin waxes having melting points in the range of about 130 to 165° F., such as, for example, Pacemaker available from Citgo, and R-2540 available from Moore and Munger; and low melting point synthetic Fischer-Tropsch waxes having a melting point of less than about 180° F. The most preferred wax is paraffin wax with a melting point of 150° F. Other paraffinic waxes include waxes available from CP Hall under the product designations 1230, 1236, 1240, 1245, 1246, 1255, 1260, & 1262. CP Hall 1246 paraffinic wax is available from CP Hall (Stow, Ohio).

The microcrystalline waxes useful here are those having 50 percent by weight or more cyclo or branched alkanes with a length of between 30 and 100 carbons. They are generally less crystalline than paraffin and polyethylene waxes, and have melting points of greater than about 70° C. Examples include Victory® Amber Wax, a 70° C. melting point wax available from Petrolite Corp. located in Tulsa, Okla.; Bareco® ES-796 Amber Wax, a 70° C. melt point wax available from Bareco in Chicago, Ill.; Okerin® 177, an 80° C. melt point wax available from Astor Wax Corp.; Besquare® 175 and 195 Amber Waxes and 80° C. and 90° C. melt point microcrystalline waxes both available from Petrolite Corp. in Tulsa, Okla.; Indramic® 91, a 90° C. melt point wax available from Industrial Raw Materials located in Smithport, Pa.; and Petrowax®) 9508 Light, a 90° C. melt point wax available from Petrowax Pa., Inc. located in New York, N.Y.

Exemplary high density low molecular weight polyethylene waxes falling within this category include ethylene homopolymers available from Petrolite, Inc. (Tulsa, Okla.) as Polywax™ 500, Polywax™ 1500 and Polywax™ 2000. Polywax™ 2000 has a molecular weight of approximately 2000, an Mw/Mn of approximately 1.0, a density at 160C of about 0.97 g/cm³ and a melting point of approximately 126° C.

The adhesives of the present invention preferably also contain a stabilizer or antioxidant. These compounds are added to protect the adhesive from degradation caused by reaction with oxygen induced by such things as heat, light, or residual catalyst from the raw materials such as the tackifying resin.

Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. The performance of these antioxidants may be further enhanced by utilizing, in conjunction therewith, known synergists such as, for example, thiodipropionate esters and phosphites. Distearylthiodipropionate is particularly useful. These stabilizers, if used, are generally present in amounts of about 0.1 to 1.5 weight percent, preferably 0.25 to 1.0 weight percent. Antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Many such antioxidants are available either to be used alone or in combination with other such antioxidants. These compounds are added to the hot melts in small amounts and have no effect on other physical properties. Other compounds that could be added that do not affect physical properties are pigments which add color, or fluorescing agents, to mention only a couple. Depending on the contemplated end use of the adhesives, other additives such as plasticizers, pigments and dyestuffs conventionally added to hot melt adhesives might be included. Additives like these are known to those skilled in the art.

The hot melt adhesive formulations of the invention comprise a solid phase comprising a gelling agent and a liquid phase comprising a thermoplastic polymer and a tackifier. The solid phase is advantageously a polyethylene (PE) homopolymer or copolymer wax. In a preferred embodiment, the liquid phase comprises an ethylene vinyl acetate polymer and the tackifying resin is a hydrocarbon tackifying resin, and the solid phase comprises a branched PE wax. The branched PE wax precipitates to form a physical cross-linked network in an otherwise molten formulation of ethylene vinyl acetate copolymer, synthetic wax, and hydrocarbon tackifying resin. The process of physical cross-linking for the branched PE wax is a crystallization phenomenon that results with the ends of chain segments affixed with one another.

Any combination of these ingredients such that distinct gelatin properties are achieved at application temperatures, specifically the formation of a three-dimensional lattice network comprised of precipitated fine polyethylene wax particles at application temperature. The existence of this network in conjunction with a liquid phase comprised of the polymer and preferable also tackifier components creates gelation properties by restricting the flow of the liquid phase.

The adhesive is applied to a substrate while in its molten state and cooled to harden the adhesive layer. Adhesives of the invention are preferably formulated for application at a temperature of 200 to 350° F. In one embodiment, the adhesive will be in a gelation state during application. In another embodiment, the adhesive will pass through the gel state after application to the substrate. Particularly preferred hot melt adhesive compositions exhibit gelatin properties over at least a 25° F. temperature range.

The adhesive product can be applied to a substrate such as a paper or paperboard or cardboard substrate, nonwoven article, etc, by a variety of methods including coating, spraying extrusion, contact extrusion and the like in an amount sufficient to cause the substrate to adhere to another substrate.

The invention provides a process for bonding a substrate to a similar or dissimilar substrate comprising applying to at least a first substrate a molten hot melt adhesive composition, bringing a second substrate in contact with the composition applied to the first substrate, whereby the first and second substrates are bonded together, wherein said hot melt adhesive exhibits gelatin properties. In one embodiment the adhesive applied to one substrate is contacted to the adhesive applied to a second substrate to bond the first substrate to the second substrate. It will be appreciated that the first and second substrates may be different regions of the same substrate.

Formulated adhesives of the invention have superior machining and flow properties, high green strength, high heat resistance, enhanced elasticity, low substrate bleed through on porous substrates. These properties makes the adhesives of the invention well suited for use in packaging, converting, bookbinding, bag ending and in the nonwovens markets. The adhesives find particular use as case, carton, and tray forming, and as sealing adhesives, and have been found to be ideally suited for use for filter pleating construction. Hot melt adhesives are generally extruded in bead form onto a substrate using piston pump or gear pump extrusion equipment. Hot melt application equipment is available from several suppliers including Nordson, ITW and Slautterback.

The adhesives are useful in the manufacture of all types of filters, and in particular pleated filters. The adhesives of the invention may advantageously be used in the manufacture of pleated sheets of paper or fabric for use in, e.g., filters for room humidifiers. Humidifiers are used to add moisture to dry air within a room being heated. Humidifier filters operate as a wicking element to draw water by capillary action from a reservoir into an evaporative area of the wicking element from where water is evaporated into the air drawn through the wicking element by a fan for discharge into the room. Other uses include but are not limited to filters used for air cleaning or purifying, such as HEPA (High Efficiency Particulate Air) filters and vacuum filter bags. The paper used in such filters may be treated to retain impurities in the air by physical or chemical means. Still other filters include water filters used for the filtration of public water supplies, home tap water, swimming pools, hot tubs, Jauzzi(s, hydrotherapy pools and the like. Such filter may include antimicrobial agents or the like.

The adhesive of the invention is applied to a flat filter media (absorbent paper or fabric) prior to being pleated, e.g., in a conventional pleating machine such as that manufactured by Solent Technologies and Geyer. Non-woven substrates are particularly useful in filter applications. During the pleating process, the filter media is typically pleated at least every inch, withstanding a 180 degree bend throughout every inch. Adhesives of the invention perform well when applied to flat filter paper prior to being pleated. The extent of gellation can be manipulated to provide a desired bead height and retention thereof such that when pleating occurs, the adhesive serves to hold the filter in a pleated form and properly space the pleats. In the practice of this embodiment of the invention, adhesive is typically applied in a straight line (either continuous or discontinuous) on a substrate to be pleated. Pleating typically occurs so that the pleats run substantially perpendicular, preferably perpendicular, to the line of adhesive so that during the pleating operation, the adhesive present on one portion of the substrate contacts the adhesive present on a next portion of the substrates thereby forming a set pleat. In filter pleating applications there is an adhesive to adhesive interface, the bead sets up well and resists flow. The pleated articles may be used as a pleated sheet material or may be formed into a cylinder or may be manufactured in the form of a cone or the like.

In addition to pleated filters, other pleated articles include, without limitation, packaging materials, insulation materials and the like.

The substrates to be bonded include virgin and recycled kraft, high and low-density kraft, chipboard and various types of treated and coated kraft and chipboard. Composite materials are also used for packaging applications such as for the packaging of alcoholic beverages. These composite materials may include chipboard laminated to an aluminum foil which is further laminated to film materials such as polyethylene, mylar, polypropylene, polyvinylidene chloride, ethylene vinyl acetate and various other types of films. Additionally, these film materials also may be bonded directly to chipboard or kraft. The aforementioned substrates by no means represent an exhaustive list, as a tremendous variety of substrates, especially composite materials, find utility in the packaging industry.

The following examples are provided for illustrative purposes only.

### EXAMPLES

### Example 1

Adhesive samples were prepared having the formulations shown in Table 1. Sample 1 is an example of a gel type hot melt, Sample 2 is an example of a strong gel type hot melt and Comparative Sample 3 is an example of a standard hot melt.

TABLE 1

| Material | Sample 1 | Sample 2 | Sample 3 |
|---|---|---|---|
| Dupont Elvax 410 EVA | 35 | 15 | 35 |
| Exxon ECR-186 Hydrocarbon | 35 | 45 | 35 |
| Tackifier | | | |
| Marcus 300 Synthetic PE Wax | 20 | 20 | 30 |
| Eastman Epolene C-17 PE Wax | 10 | 20 | — |

### Example 2

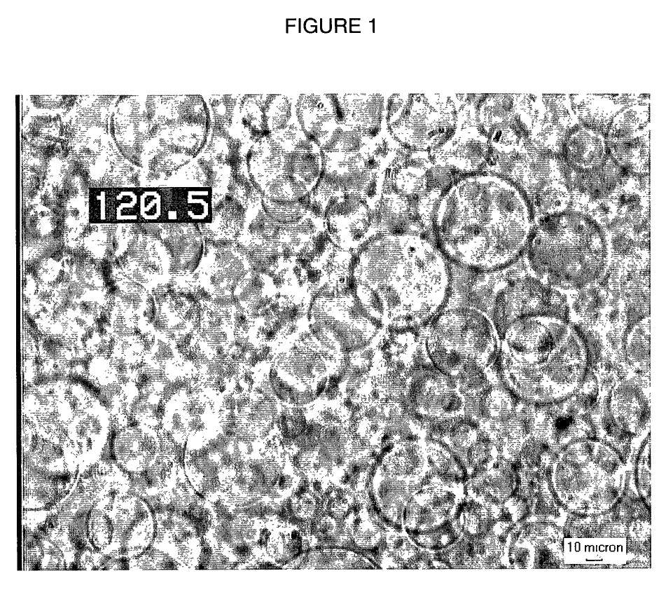

Micrographs taken of adhesive Samples 1-3 were prepared. The precipitated PE network can be seen in FIGS. 1-3. The spherical entities shown in FIGS. 1-3 are PE wax particulates with some degree of physical cross-linking surrounded by the unresolved molten components.

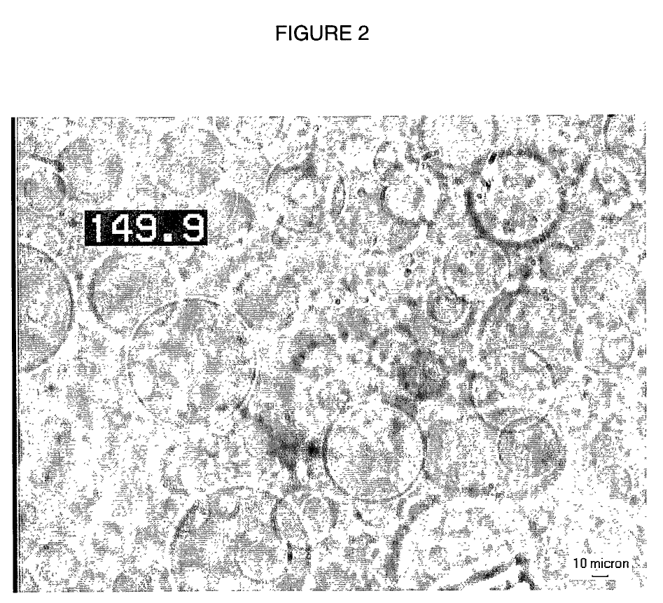

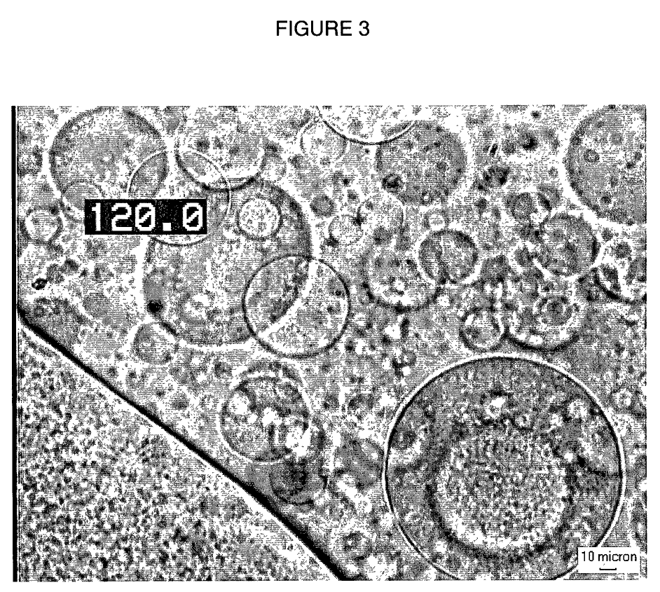

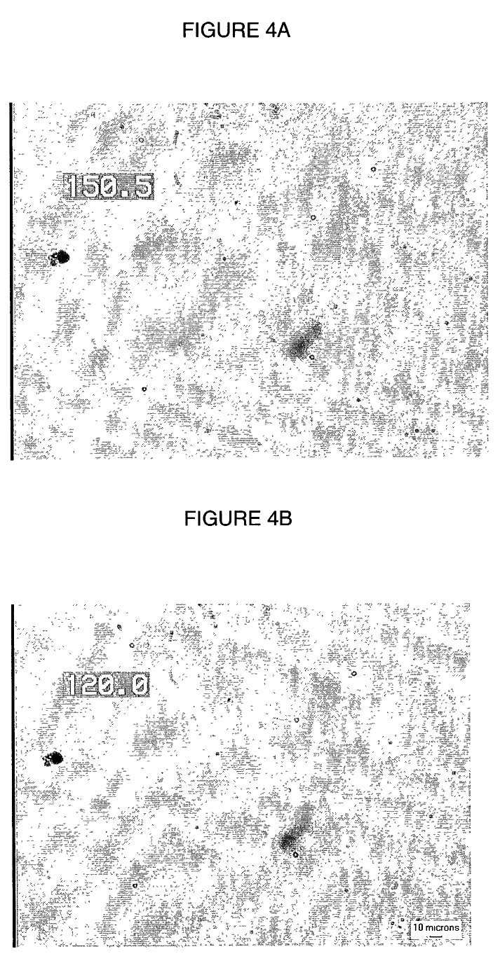

FIG. 1 is a micrograph of adhesive Sample 1 in a gelatin state with ten percent gellant additive (Epolene C-17) at 120.5° C. FIG. 2 is a micrograph illustrating the gelation properties of adhesive Sample 1 at 149.9° C. FIG. 3 is a micrograph of adhesive Sample 2 in a gelatin state with twenty percent gellant. FIGS. 4A and 4B are micrographs of an adhesive (at 150.5° C. and 120° C., respectively) lacking a gellant.

FIG. 2 illustrates the effect application temperature has on the adhesive microstructure. The higher temperature micrograph exhibits a less extensive network of PE wax particulates corresponding to a weaker gel.

An illustration of the effect gellant concentration has in the formulation is shown in FIG. 3. FIG. 3 is a micrograph of Sample 2, which formulation has twice the gelling agent present in Sample 1. Sample 2 (FIG. 3) was observed to have larger domains at 120° C. than Sample 1. A decrease in the number of smaller domains with a corresponding skew of the size range towards larger sized domains, probably due to coalescence, was noted in Sample 2. This change is consistent with an increase in gelatin characteristics because the semisolid gelatin network is becoming larger on a molecular level. It is logical that a larger microscopic semisolid gelatin network will provide increased macroscopic properties in term of performance characteristics such as resistance to flow. It is important to note that FIG. 3 exhibits increased network size in response to increased gellant incorporation however a similar result could be obtain wherein the network does not coalesce but increases surface area. Increased surface area without coalescence would provide greater interaction between the semisolid network and the liquid phase while also increasing the size of the network with respect to concentration. This alternative microscopic response to more gellant can provide the same macroscopic performance characteristics of gels.

A standard hot melt adhesive (Sample 3) formulated without a gelling agent is presented in FIGS. 4A and 4B for comparison with gel hot melt adhesives (FIGS. 1, 2 and 3). The lack of gelatin component in Sample 3 produces a micrograph with no evidence of a semisolid network. This further illustrates the dependence of macroscopic gelatin characteristics on the presence of a microscopic semisolid network.

### Example 3

Green strength of a hot melt adhesive is defined as the amount of strength a bond has at some time prior to the bonds' adequate time to cool and achieve final bond strength. The bond force is recorded along with the bonded time and reported as green strength. Most hot melt adhesives relevant to this invention reach their final bond strength within ten seconds and green strength interest is in the zero to three second range. Another method for analyzing green strength utilizes a rheometer. A rheometer instrument can induce specified forces on a sample at a variety of temperatures and measure the response of a sample to those forces. Green strength is commonly indicated in terms of the storage modulus determined by rheometric analysis. Storage modulus is a measure of the mechanical strength.

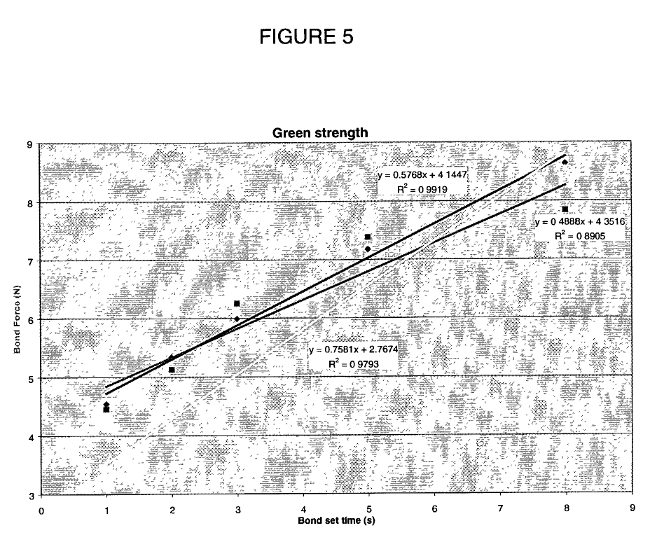

Green strength analysis of gelatin hot melts were conducted with bond force and rheology. Bond force analysis was conducted on bonds made with one tenth of one-inch adhesive bead width applied at one hundred fifty degrees centigrade to porous filter substrate. FIG. 5 is a graft comparing bond forces versus bond time for two gelatin (Gel 1 and Gel 2) and one standard (Control) hot melt adhesive. The standard hot melt has substantially lower bond forces in the one to three second range indicating a lower green strength. The graph also show the bonds strengths for the three adhesives intersect around six seconds as they approach maximum bond strength and form completely set bonds.

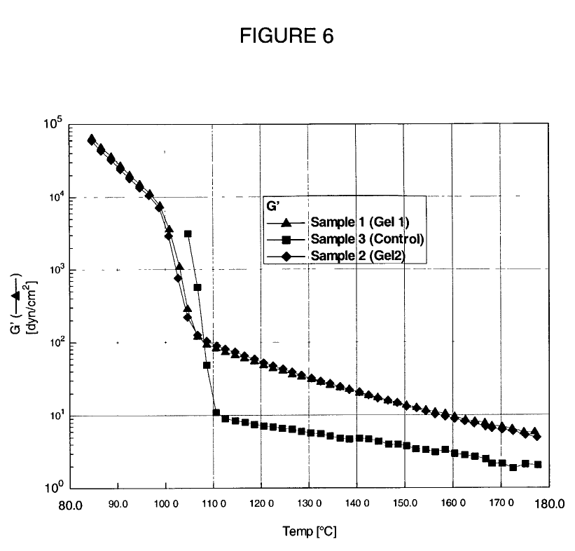

The storage modulus of an adhesive around the temperature it is applied indicates the mechanical strength of the adhesive at application temperature. Rheometers can measure the storage modulus across a range of temperatures and by comparing these curves a determination can be made of what temperature an adhesive builds mechanical strength. Higher storage modulus at higher temperatures indicates a larger green strength. FIG. 6 illustrates rheometric curves for the samples analyzed by bond forces in FIG. 5. The rheometric data illustrates that the control sample has an order of magnitude lower storage modulus than the gel samples at elevated temperatures. This data reaffirms the bond force analysis indicating that the gel adhesives have a higher green strength.

### Example 4

Bleed through of adhesive on porous substrates can be determined by visual inspection. The adhesive in question is applied to a porous substrate of interest, preferably a nonwoven, and allowed to equilibrate at the temperature of interest. After adhesive application and equilibration the reverse side of the substrate is visually inspected and reported as a high, medium, or low amount adhesive permeation of the substrate. In some cases it is relevant to change the time frame, substrate porosity, substrate thickness, or equilibration temperature to better understand the adhesives propensity for bleed through.

Table 2 shows the bleed through results for the Samples listed in Table 1. The samples were inspected one hour after application and equilibration to room temperature and twenty-four hours after equilibration to 120° C. The substrate utilized is a porous filter paper media. The gel adhesive samples (Samples 1 and 2) show less bleed through than the control formulation (Sample 3).

TABLE 2

| | Sample 1 | Sample 2 | Sample 3 |
|---|---|---|---|
| One hour equilibration @ RT | None | None | Low |
| Twenty-four hour equilibration @ | Low | Low | High |
| 120° C. | | | |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A hot melt adhesive comprising a gelling agent, a thermoplastic polymer, and a tackifying resin which adhesive exhibits distinct gellation properties at or some time after application.

2. The adhesive of claim 1 which is applied at a temperature of from about 200 to about 350° F.

3. The adhesive of claim 1 wherein the gelling agent is a polyethylene wax homopolymer or copolymer wax or blends thereof.

4. The adhesive of claim 3 wherein said polyethylene wax is selected from the group consisting of oxidized homopolymers, oxidized high density polyethylene, ethylene vinyl acetate, ethylene acrylic acid, maleic anhydride copolymers and blends thereof.

5. The adhesive of claim 1 wherein distinct gellation properties are present over at least a 25° F. temperature range at or below the application temperature.

6. The adhesive of claim 1 further comprising a wax

7. The adhesive of claim 1 further comprising a non-gel forming wax.

8. The adhesive of claim 1 wherein the adhesive polymer comprises at least one ethylene copolymer.

9. The adhesive of claim 8 comprising at least one ethylene vinyl acetate copolymer.

10. The adhesive of claim 7 wherein the wax is a paraffin, a microcrystalline wax or a blend thereof.

11. The adhesive of claim 8 comprising ethylene n-butyl acrylate and/or ethylene 2-ethyl hexyl acrylate.

12. An article of manufacture comprising a hot melt adhesive of claim 1.

13. The article of claim 12 which is a case, carton, tray, bag, book diaper, pleated article.

14. The article of claim 13 which is a pleated filter.

15. A process for bonding a first substrate to a similar or dissimilar second substrate comprising applying to at least a first substrate a molten hot melt adhesive composition, bringing a second substrate in contact with the composition applied to the first substrate, whereby the first and second substrates are bonded together, said hot melt adhesive comprising the adhesive of claim 1.

16. A method of making a pleated article comprising applying a line of the adhesive of claim 1 to a substrate to be pleated and pleating the substrate, wherein the pleats are formed substantially perpendicular to the direction of the line of adhesive, whereby adhesive present on one surface of a pleat contacts adhesive present on a surface of an adjacent pleat forming a bond and holding the article in pleated form.

17. The method of claim 16 wherein the substrate is a nonwoven material.

18. The method of claim 16 wherein said line is a discontinuous line.

19. The method of claim 16 wherein said line is a continuous line.

20. The method of claim 16 wherein at least two lines of adhesive are applied to the substrate to be pleated.
